(19) United States
(12) Patent Application Publication
(10) Pub. No.: US 2006/0238523 A1
(43) Pub. Date: Oct. 26, 2006

(54) 3D display

(76) Inventors: Jeffrey H. Hunt, Thousand Oaks, CA (US); Peter S. Wittenberg, Creve Coeur, MO (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/114,739

(22) Filed: Apr. 25, 2005

(51) Int. Cl. G09G 5/00

(52) U.S. Cl. 345/204

(57) ABSTRACT

A three dimensional display has an array of quantum dots configured to provide phase controlled light that defines a three dimensional image. A quantum dot driver can be used to determine which quantum dots are activated and when they are activated. A three dimensional phase pattern generator can be used to determine a phase pattern of light from the array of quantum dots that will provide a three dimensional image corresponding to a video signal provided thereto.

### TECHNICAL FIELD

The present invention relates generally to displays, such as those used to show images and motion pictures. The present invention relates more particularly a three dimensional (3D) display suitable for reproducing 3D still images and motion pictures.

### BACKGROUND

Displays using cathode ray tubes, plasma, liquid crystals, and a variety of different projection systems are well known. Such contemporary displays provide two dimensional (2D) images, such as those commonly associated with computer graphics, television, and motion pictures.

Although three dimensional displays are also known, contemporary three dimensional displays utilize holographic systems. As those skilled in the art will appreciate, holographic display systems are cumbersome and costly because they require special illumination. Further, motion pictures produced with such system tend to be of low quality and have limited fields of view. This makes contemporary three dimensional motion pictures difficult to view and detracts substantially from their desirability.

As a result, there is a need for a three dimensional display that overcomes these deficiencies in the prior art. It is therefore desirable to provide a non-holographic method and system for producing three dimensional still images and motion pictures that has adequate quality and enhanced field of view.

### SUMMARY

Systems and methods are disclosed herein to provide a three dimensional display. For example, in accordance with one embodiment of the present invention, phase relationships of light produced by quantum dots are controlled so as to produce a three dimensional image.

More specifically, in accordance with one embodiment of the present invention, a three dimensional display comprises a three dimensional phase pattern generator, a quantum dot driver, and an array of quantum dots. The three dimensional phase pattern generator determines a phase pattern of light emitted from the array of quantum dots that will provide a three dimensional image corresponding to a frame of a three dimensional video signal provided thereto. The quantum dot driver determines which quantum dots are activated and when they are activated, so as to produce the necessary phase pattern.

According to one embodiment of the present invention, the quantum dots can be formed so as to each emit one of three primary colors. The quantum dot array can thus be controlled so as to form three dimensional color images.

Thus, one or more embodiments of the present invention can be used to produce three dimensional, color, moving pictures having enhanced quality and field of view. These moving pictures can be used in a variety of different applications, such as entertainment, medical imaging, and telepresence.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a representative portion of a quantum dot array configured for use as a three dimensional display, in accordance with an exemplary embodiment of the present invention;

FIG. 2 shows a block diagram illustrating use of the quantum dot array of FIG. 1 in a three dimensional display system, in accordance with an exemplary embodiment of the present invention; and

FIG. 3 shows a flow chart illustrating operation of the three dimensional display system of FIG. 2, in accordance with an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

Quantum dots are very small light emitting devices that are fabricated from semiconductor materials. The color of the light emitted depends upon the size of the quantum dot. The smaller the quantum dot, the higher the energy of the light that it emits. Thus, quantum dots that emit blue light are smaller than quantum dots that emit red light.

According to one aspect of the present invention, quantum dots are used not only as color sources, but also as devices for controlling the phase relationships of light that impinges upon the retina of a viewer's eye. As those skilled in the art will appreciate, it is this phase information that is key to forming three dimensional images.

The three dimensional images formed by holograms are the result of controlling the phase of light that passes through or is reflected from a diffraction grating that is defined by the patterns formed in the holographic medium. That is, a contemporary hologram controls the phase relationships of light that impinges upon the retina of a viewer's eye.

According to one aspect of the present invention, the way that phase relationships of light that that impinges upon the retina of a viewer's eye via holography is mimicked using non-holographic methodology. More particularly, an array of quantum dots control these phase relationships. They do this by functioning as a phase array that emits coherent, phase controlled light that is much the same as the light from holographic media. Therefore, such quantum dots are capable of producing three dimensional images.

Coherent, phase controlled emission of light from a quantum dot array is possible since the size of quantum dots is much smaller that the wavelength of visible light and since individual quantum dot can rapidly be turned on and off. Thus, the phase relationship of light from one quantum dot with respect to other quantum dots can be controlled. Because of this, a phased array of quantum dots can be fabricated and used to form three dimensional images.

The color of light emitted from an array of quantum dots can be controlled by activating only those quantum dots that produce the desired colors. Since the color of light emitted by the quantum dots can easily be controlled, a single array of quantum dots is capable of producing three dimensional color images. Since quantum dots can easily be controlled in real time, moving pictures can be provided.

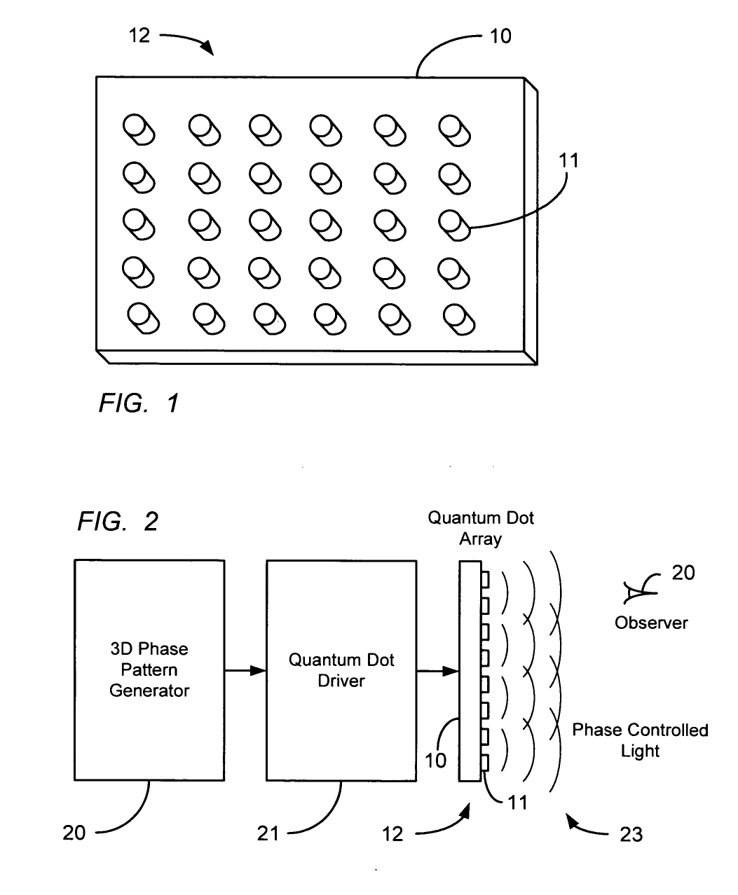

FIG. 1 shows a representative portion of quantum dot array 12 configured for use as a three dimensional display, in accordance with an exemplary embodiment of the present invention. Quantum dot array 12 comprises a substrate 10 upon which a plurality of individual quantum dots 11 are formed. Electrodes and traces (not shown)facilitate the application of electrical power to selected quantum dots 11 according to well known principles.

Quantum dots 11 can be formed to produce primary colors, so as to facilitate the formation of full color, three dimensional images. For example, quantum dots 11 can be formed so as to emit red, blue, and green light. That is, some will emit red light, some will emit blue light, and some will emit green light. Alternatively, quantum dots 11 can be formed so as to emit cyan, magenta, and yellow light. As a further alternative, quantum dots 11 can be configured to produce fewer or more than three colors. For example, more than three colors (five, for example) can be used to enhance color capability and/or better address the full range of human perception.

As those skilled in the art will appreciate, the color emitted from a quantum dot 11 is dependent upon the size thereof. Quantum dots 11 can be positioned upon substrate 10 such that groups of three or more thereof define a pixel. The pixel can be of a desired color, dependent upon which quantum dots 11 of the pixel are emitting light.

For example, consecutive columns of red, blue, and green quantum dots 11 can form a repeating pattern. A single pixel can then be defined as three consecutive quantum dots in a row. Thus, the pixel contains one red quantum dot, one blue quantum dot, and one green quantum dot. Alternatively, quantum dots of different colors can be arranged or clustered in any other desired manner to define pixels.

FIG. 2 shows a block diagram illustrating use of the quantum dot array 12 of FIG. 1 in a three dimensional display system, in accordance with an exemplary embodiment of the present invention. A three dimensional pattern generator 20 is in electrical communication with a quantum dot driver 21. Three dimensional pattern generator 20 is configured to receive a three dimensional video signal and to provide an output to quantum dot driver 21 that is representative of the three dimensional video signal, as discussed below.

Quantum dot drive 21 is in electrical communication with quantum dot array 12. Quantum dot driver 21 receives the output of three dimensional pattern generator 20 and provides control signals to quantum dot array, as discussed below.

Light 23 from quantum dot array 12 has the desired intensities, frequencies, and phase relationships to provide a three dimensional, color, motion picture to observer 20. That is, the quantum dots 11 emit light that has characteristics of light from holographic media.

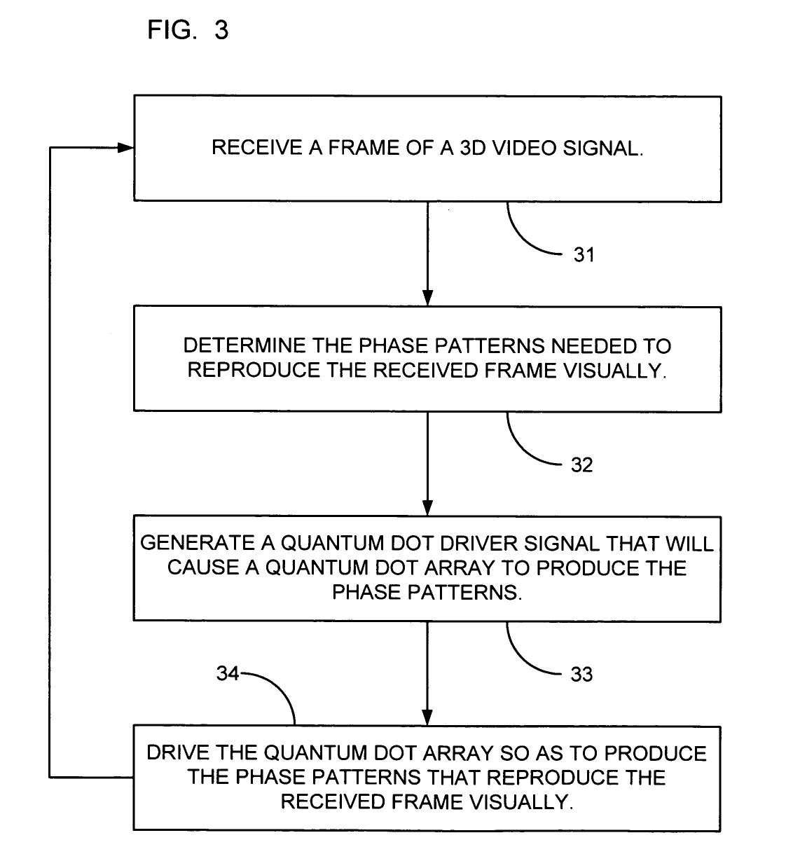

FIG. 3 shows a flow chart illustrating operation of the three dimensional display system of FIG. 2, in accordance with an exemplary embodiment of the present invention. Three dimensional phase pattern generator 20 receives a frame of a three dimensional video signal, as indicated in block 31. This signal can be analogous to that which may be used to drive a contemporary holographic three dimensional motion picture system.

Three dimensional phase pattern generator 20 determines the phase patterns needed to reproduce the received frame visually, as indicated in block 32. This process can be considered to be analogous to that used to determine the diffraction patterns needed to produce three dimensional images in a contemporary holographic three dimensional motion picture system.

A signal representative of the desired phase patterns is provided by three dimensional phase pattern generator 20 to quantum dot driver 21. Quantum dot driver 21 determines which quantum dots 11 must be activated and the timing of activation required, so as to produce light 23 therefrom with phase relationships that produce the desired three dimensional image for observer 20.

In this manner, quantum dot array 12 mimics the way in which a hologram provides light having phase patterns that produce a three dimensional image. Thus, light 23 is substantially like that from a hologram. That is, quantum dots 11 are activated in a manner that simulates, at least to some degree, the effect of light passing through or reflected from a holographic diffraction grating.

Embodiments described above illustrate but do not limit the invention. It should also be understood that numerous modifications and variations are possible in accordance with the principles of the present invention. Accordingly, the scope of the invention is defined only by the following claims.

We claim:

1. A three dimensional display comprising an array of quantum dots configured so as to provide a three dimensional image.

2. A three dimensional display system comprising:
an array of quantum dots;
a quantum dot driver in electrical communication with the array of quantum dots and configured to determine which quantum dots are activated and when they are activated; and
a three dimensional phase pattern generator in electrical communication with the quantum dot driver and configured to determine a phase pattern of light from the array of quantum dots that will provide a three dimensional image corresponding to a video signal provided thereto.

3. The three dimensional display system of claim 2, wherein a diameter of the quantum dots and a spacing of the quantum dots are both substantially smaller than the shortest visible wavelength of light produced thereby.

4. The three dimensional display system of claim 2, wherein the quantum dots comprise quantum dots configured to produce a plurality of colors.

5. The three dimensional display system of claim 2, wherein the quantum dots comprise quantum dots configured to produce three colors.

6. The three dimensional display system of claim 2, wherein the quantum dots comprise quantum dots configured to produce three colors, the three colors being one of red/blue/green and cyan/magenta/yellow.

7. The three dimensional display system of claim 2, wherein the quantum dots comprise quantum dots configured to produce substantially coherent light.

8. The three dimensional display system of claim 2, wherein the quantum dots are configured to provide a substantially phase coherent image.

9. The three dimensional display system of claim 2, wherein the quantum dots are configured to facilitate three dimensional viewing of a color motion picture.

10. The three dimensional display system of claim 2, wherein the array of quantum dots comprises a substantially planar array of quantum dots.

11. The three dimensional display system of claim 2, wherein the array of quantum dots comprises a substrate formed of one semiconductor material and a plurality of dots formed of a different semiconductor material.

12. The three dimensional display system of claim 2, wherein the quantum dots are generally circular in shape.

13. A three dimensional display system comprising:
an array of quantum dots;
driver means in electrical communication with the array of quantum dots and configured to determine which quantum dots are activated and when they are activated; and
pattern generation means in electrical communication with the quantum dot driver and configured to determine a phase pattern of light from the array of quantum dots that will provide a three dimensional image corresponding to a video signal provided thereto.

14. A method of providing a three dimensional image, the method comprising controlling phase relationships of light produced by quantum dots.

15. The method of claim 14, wherein controlling the phase relationships of quantum dots comprises controlling the phase relationships of quantum dots capable of producing light having a plurality of different colors so as to facilitate the formation of an image having a plurality of colors.

16. The method of claim 14, wherein the quantum dots comprise quantum dots configured to produce three colors, the three colors being one of red/blue/green and cyan/magenta/yellow.

17. The method of claim 14, wherein the quantum dots are configured so as to provide substantially coherent light emission.

18. The method of claim 14, wherein the quantum dots are configured so as to provide a substantially phase coherent image.

19. The method of claim 14, wherein the quantum dots define an array and phase relationships of light emitted at different portions of the array are controlled so as to provide a three dimensional image.

20. The method of claim 14, wherein the quantum dots define a substantially planar array.

21. The method of claim 14, wherein controlling phase relationships of light produced by quantum dots comprises:
determining a phase pattern of light from the array of quantum dots that will provide a three dimensional image corresponding to a video signal; and
determining which quantum dots are to be activated and when they are to be activated so as to provide the phase pattern.

22. The method of claim 14, wherein controlling phase relationships of light produced by quantum dots comprises:
using a three dimensional phase pattern generator to determine a phase pattern of light from the array of quantum dots that will provide a three dimensional image corresponding to a video signal; and
using a quantum dot driver to determine which quantum dots are to be activated and when they are to be activated so as to provide the phase pattern.
